(19) United States
(12) Patent Application Publication
(10) Pub. No.: US 2017/0298657 A1
(43) Pub. Date: Oct. 19, 2017

(54) DUAL CABLE DOOR LATCH RELEASE MECHANISM

(71) Applicant: Ford Global Technologies, LLC, Dearborn, MI (US)

(72) Inventors: Wanjun Lei, Ann Arbor, MI (US); Tahmidur Rahman, Canton, MI (US); Daniel Carl Bejune, Southfield, MI (US); Matthew B. Makowski, Northville, MI (US); Musarrat Jehan, Maumee, OH (US)

(73) Assignee: Ford Global Technologies, LLC, Dearborn, MI (US)

(21) Appl. No.: 15/098,829

(22) Filed: Apr. 14, 2016

(51) Int. Cl. E05B 77/04; E05B 79/06; E05B 79/20; E05B 85/24

(52) U.S. Cl. CPC E05B 77/04; E05B 85/243; E05B 79/06; E05B 79/20

(57) ABSTRACT

A door latch release mechanism for use in a passenger vehicle comprises at least one of a latch mechanism and a handle mechanism. The latch mechanism includes a first bellcrank with a first pivot axis and two mounting points. The handle mechanism includes a second bellcrank with a second pivot axis and two mounting points. The handle mechanism further includes a door handle having a third pivot axis, and a mechanical linkage connecting the door handle lever with the second bellcrank.

### BACKGROUND

It is desired to prevent motor vehicle doors from unintentionally opening during an impact event. A side impact event may cause a motor vehicle door to become unlatched, with a door latch no longer being engaged with an associated striker.

### BRIEF DESCRIPTION OF THE DRAWINGS

FIG. 1 is a perspective interior view of an exemplary vehicle door.

FIG. 2 is a schematic view of an exemplary prior-art door single cable latch release mechanism.

FIG. 3 is a view of the latch mechanism of FIG. 2 in a direction of arrow 3 in an unlatched condition.

FIG. 4 is a view of the latch mechanism of FIG. 3 in an latched condition.

FIG. 5 is a schematic top view of the latch release mechanism of FIG. 2 in the context of an exemplary door.

FIG. 6 is a schematic view of the latch mechanism of FIG. 5 in the direction of arrow 6.

FIG. 7 is schematic view of the mechanism of FIG. 5 with the cable deflected.

FIG. 8 is a schematic view of the latch mechanism of FIG. 7 in the direction of arrow 8.

FIG. 9 is a schematic view of an exemplary dual cable door latch release mechanism in a latched condition in solid lines and in an unlatched condition in phantom lines.

FIG. 10 is a schematic view of the exemplary dual cable door latch release mechanism of FIG. 9 in the latched condition with the cables deflected.

FIG. 11 is a plot comparing latch arm movement with bellcrank movement as a function of time when the system is subjected to an impingement.

### DETAILED DESCRIPTION

### Introduction

A disclosed door latch release mechanism has a bellcrank connected to one of a latch mechanism and a door handle mechanism, the bellcrank having a pivot axis and two mounting points disposed on the bellcrank.

In the event of a vehicle impact event, it is desirable to maintain the door latch in engagement with a striker. The door latch is disposed in a door. The striker is fixed to a door jamb. Engagement between the latch and the striker prevents the door from opening. A side impact event may cause the latch to move to an unlatched position in which it is no longer engaged with the striker. One cause for such unlatching has been identified for door latch release mechanisms having a cable disposed between an interior door handle and a latch mechanism. When the door is impacted and deformed to an extent that the cable has been stretched or tensioned, the effect on the latch mechanism is the same as if the door handle has been pulled to open the door. A latch of the latch mechanism disengages its associated striker, allowing the door to swing open.

A door latch release mechanism for use in a passenger vehicle comprises at least one of a latch mechanism and a handle mechanism. The latch mechanism includes a first bellcrank with a first pivot axis and two mounting points. The handle mechanism includes a second bellcrank with a second pivot axis and two mounting points. The handle mechanism further includes a door handle having a third pivot axis, and a mechanical linkage connecting the door handle lever with the second bellcrank.

Relative orientations and directions (by way of example, upper, lower, bottom, rearward, front, rear, back, outboard, inboard, inward, outward, lateral, let, right, clockwise, counterclockwise) are set forth in this description not as limitations, but for the convenience of the reader in picturing at least one embodiment of the structures described. Such exemplary orientations are from the perspective of an occupant seated in a driver seat, facing a dashboard.

### Exemplary System Elements

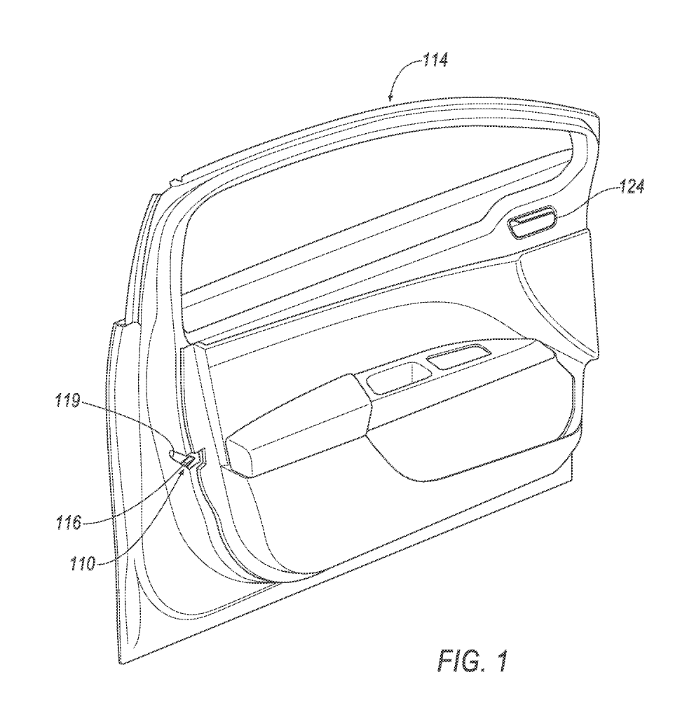

A door latch release mechanism 110 is disposed in a door 114 as illustrated in FIG. 1. The illustrated embodiment door latch release mechanism 110 is of the prior art, but an exemplary improved embodiment, discussed later below, can have an identical appearance when it is enclosed by an assembled door.

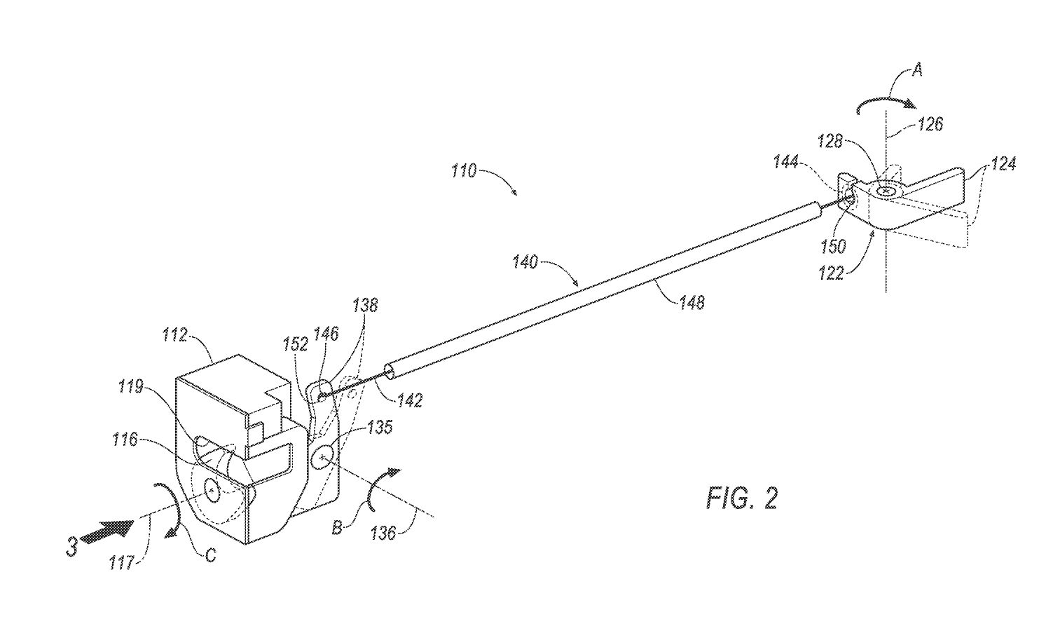

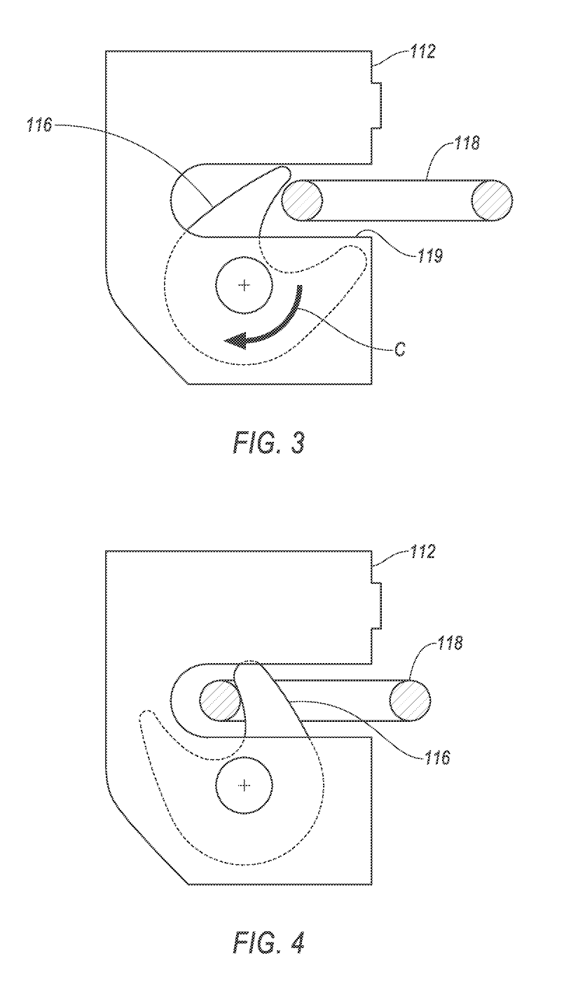

The prior art door latch release mechanism 110 is illustrated in FIGS. 2 through 8. A latch mechanism 112 is disposed in a vehicle door 114 and includes a latch 116. As illustrated in FIG. 3, in an unlatched or open position, latch 116 is in a receiving position with respect to a striker 118, allowing striker 118 to move into and out of a retaining notch 119 in mechanism 112. Striker 118 is fixed to a door jamb 120. As illustrated in FIG. 4, latch 116 is disposed across striker 118 in a latched or closed position, maintaining striker 118 within notch 119 and door 114 in a closed position. With latch 116 in the closed position, the door 114 is maintained in a closed position. Latch 116 moves between its latched or closed position and its open or unlatched position, pivoting about latch pivot axis 117.

Door latch release mechanism 110 also includes a door handle mechanism 122 disposed in door 114. Handle mechanism 122 is used to manually and remotely, via door latch mechanism 112, move latch 116 to its released position. Door handle mechanism 122 includes a release handle lever or door handle lever 124 accessible to a vehicle occupant and disposed on an inboard or interior side of door 114. Door handle lever 124 pivots about door handle pivot axis 126 defined by a door handle hinge pin 128 passing through an aperture in handle lever 124 and an associated aperture (not shown) in one of the door 114 and a mounting feature fixed to the door 114.

The latch mechanism 112 includes a latch actuation shaft 135 which defines a latch actuation pivot axis 136. A latch actuation lever 138 is pivotally mounted on shaft 135 for pivoting about axis 136. When lever 138 is pivoted, it causes latch 116 to move between the latched position and an open position in a well-known manner. Exemplary latch mechanisms are known in the art and can be found in most motor vehicles.

A cable assembly 140 is disposed between latch mechanism 112 and door handle mechanism 122. Cable assembly 140 includes a cable 142 with a first end fitting 144 on a first end and a second end fitting 146 on a second end. An exemplary cable sleeve 148 is slidably disposed over cable 142 and is fixed to the door 114. The first end fitting 144 connects to a first mounting point 150 on the door handle lever 124. The second end fitting 146 connects to a second mounting point 152 on the latch mechanism actuation lever 138.

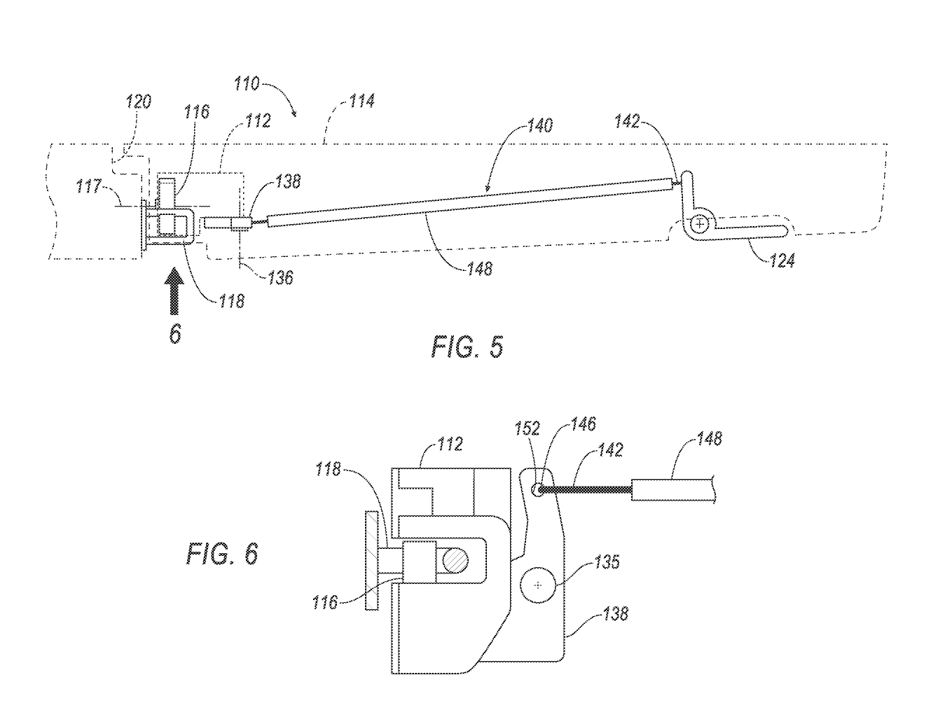

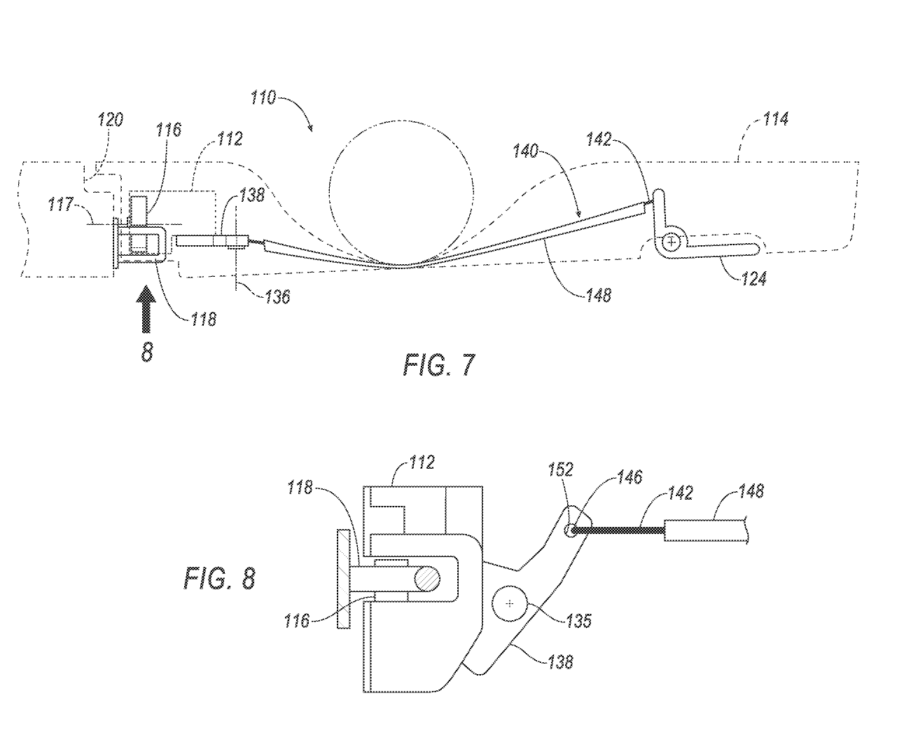

FIGS. 5 and 6 show door 114 closed and mechanisms 110 and 112 in a latched condition. FIGS. 7 and 8 show door 114 closed and deformed by a side impact and mechanisms 110 and 112 in a released/unlatched condition.

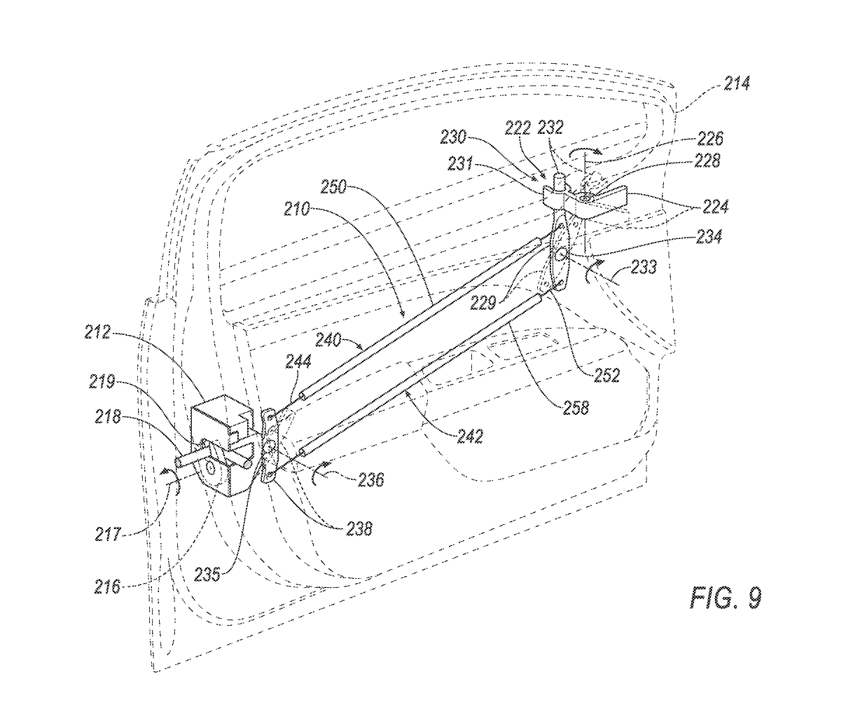

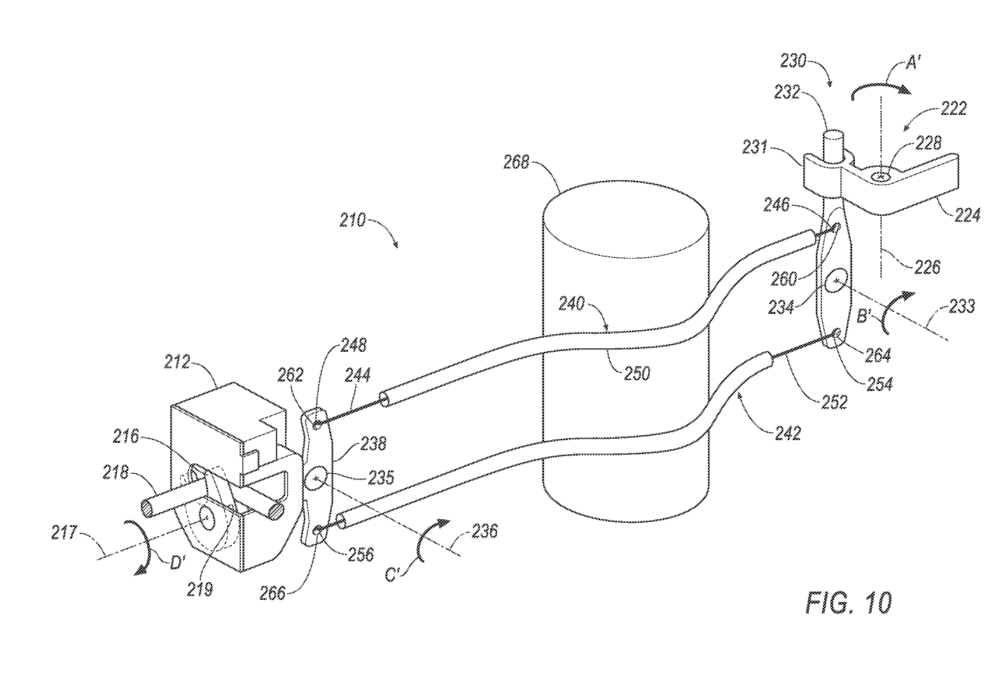

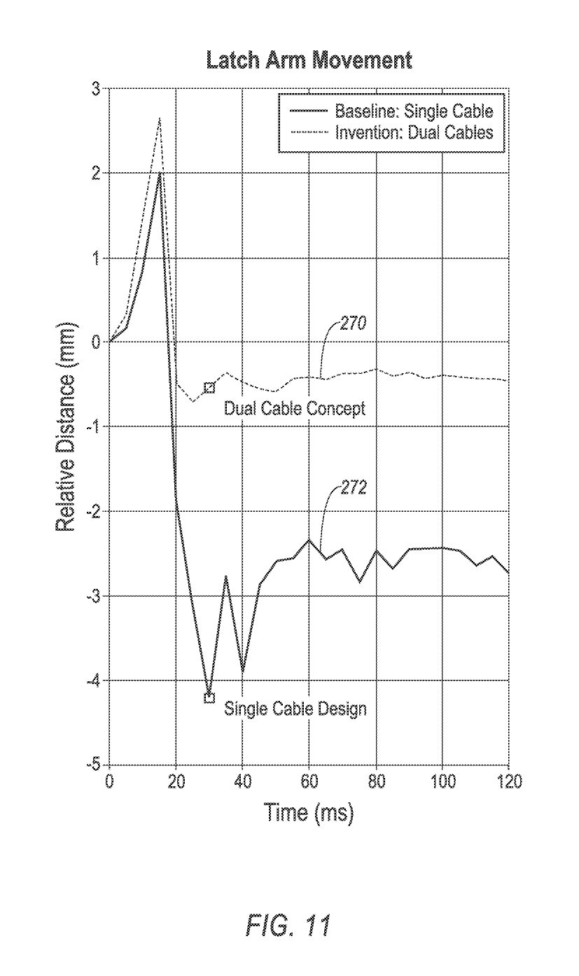

FIG. 9 illustrates an exemplary dual-cable door latch release mechanism 210. Reference numbers 210 through (excepting numbers 120 and 229-234) of FIGS. 9 and 10 correspond to reference numbers 110 through 140 of FIGS. 2 through 8. Elements having the last two digits in common are similar or analogous or in some cases identical.

A latch mechanism 212 is disposed in a vehicle door 214 and includes a latch 216. Latch 216 moves between its latched or closed position and its open or unlatched position, pivoting about latch pivot axis 217. As illustrated in FIG. 9, in an unlatched or open position, latch 216 is in a receiving position with respect to a striker 218, allowing striker 218 to move into and out of a retaining notch 219 in mechanism 212. Striker 218 is fixed to a door jamb like door jamb 120. Latch 216 is disposed across striker 218 in a latched or closed position, maintaining striker 218 within notch 219 and door 214 in a closed position, the same as the arrangement illustrated in FIG. 4. With latch 216 in the closed position, the door 214 is maintained in a closed position.

Door latch release mechanism 210 also includes a door handle mechanism 222 disposed in door 214. Handle mechanism 222 is used to manually and remotely, via door latch mechanism 212, move latch 216 to its released position. Door handle mechanism 222 includes a release handle lever or door handle lever 224 accessible to a vehicle occupant and disposed on an inboard or interior side of door 214. Door handle lever 224 pivots about door handle pivot axis 226 defined by a door handle hinge pin 228 passing through an aperture in handle lever 224 and an associated aperture (not shown) in one of the door 214 and a mounting feature fixed to the door 214. A double-ended lever or handle bellcrank 229 is pivotally connected to the door, either directly or indirectly. A mechanical linkage connects bellcrank 229 with lever 224 to cause bellcrank 229 to pivot when lever 224 pivots. An exemplary mechanical linkage 230 includes a forked end 231 on an end of handle lever 224 that slidably receives an extended end 232 of bellcrank 229. Exemplary handle bellcrank 229 is pivotally mounted relative to door 214 for pivoting about a pivot axis 233 cooperatively defined by bellcrank 229 and a handle bellcrank pivot pin 234.

The latch mechanism 212 includes a latch actuation shaft 235 which defines a latch actuation pivot axis 236. A latch actuation bellcrank 238 is pivotally mounted on shaft 235 for pivoting about axis 236. When bellcrank 238 is pivoted, it causes latch 216 to move between the latched position and an open position in a well-known manner. Exemplary latch mechanisms are known in the art and can be found in most motor vehicles, with mechanism 212 being distinguished over mechanism 112 by the use of a two-ended bellcrank 238 in place of a single ended lever 138.

A first cable assembly 240 and a second cable assembly 242 are each disposed between latch mechanism 212 and door handle mechanism 222, and more specifically between bellcranks 229 and 238. Cable assembly 240 includes a first cable 244 with a first end fitting 246 on a first end and a second end fitting 248 on a second end. An exemplary first cable sleeve 250 is slidable disposed over cable 244 and has ends fixed to relative to the door 214 proximate to bellcranks 229 and 238. Similarly cable assembly 242 includes a second cable 252 with a first end fitting 254 and a second end fitting 256 on a second of cable 252. Exemplary end fittings can be in the form of a J-shaped hook. An exemplary second cable sleeve 258 is slidably disposed over cable 252 and has ends fixed to relative to the door 214 proximate to bellcranks 229 and 238. The first end fitting 246 of cable 240 connects to a first mounting point 260 on handle bellcrank 229. The second end fitting 246 connects to a first mounting point 262 on latch actuation bellcrank 238. The first end fitting 254 of cable 242 connects to a second mounting point 264 on handle bellcrank 229. The second end fitting 256 connects to a second mounting point 266 on latch actuation bellcrank 238. First mounting point 260 and second mounting point 264 are equally spaced from handle bellcrank pivot axis 233. Similarly, first mounting point 262 and second mounting 266 are equally spaced from latch actuation axis 236.

### Processing

The benefit of the disclosed door latch release mechanism 210 is better understood by first understanding the operation of the prior art door latch release mechanism 110.

In normal operation, when the door 114 is open, exemplary latch 116 is in the unlatched position shown in FIG. 3 for receiving striker 118. Striker 118 is aligned with retaining notch 119 and is received thereby when door 114 is closed. As door 114 is closed, latch 116 presses against striker 118, and pivots counterclockwise, about axis 117. A lower portion of latch 116 traps striker 118 in notch 119, maintaining door 114 in the closed condition, as illustrated in FIG. 4. A passenger inside the vehicle is able to open door 114 from inside by pulling on door handle lever 124. Pulling on handle lever 124 displaces first end fitting 144 of cable 142 in the direction of arrow A, in turn displacing second end fitting 146. As second end fitting 146 is connected to actuation lever 138 at second mounting point 152, lever 138 pivots in the direction of arrow B responsive to the passenger pulling on handle lever 124. The pivoting of lever 138, through the operation of latch mechanism 112, causes the pivoting of latch 116 in the direction of arrow C from the latched position of FIG. 4 to the unlatched position of FIG. 3.

Upon the occurrence of a side impact event as illustrated in FIG. 7, cable assembly 140 is displaced from its normal position. With sufficient displacement of cable assembly 140 such that cable sleeve 148 has an end displaced relative to its normal mounting point on door 114, cable 142 is subjected to tension that causes actuation lever 138 to pivot to the unlatched position illustrated in FIG. 8, much like when door handle lever 124 is pulled, moving latch 116 to the unlatched position illustrated in FIG. 3. With latch 116 in the unlatched position, door 114 is allowed to swing open.

The exemplary embodiment of FIG. 9 and FIG. 10 operates substantially the same as the above-describe prior art system, but resists unlatching when subjected to a side impact event. In normal operation, when the door 214 is open, exemplary latch 216 is in an unlatching position like latch 116 shown in FIG. 3 for receiving striker 218. Striker 218 is aligned with retaining notch 219 and is received thereby when door 214 is closed. As door 214 is closed, latch 216 presses against striker 218, and pivots counterclockwise, about axis 217. A lower portion of latch 216 traps striker 218 in notch 219, maintaining door 214 in the closed condition, as illustrated in FIG. 4 with latch 116 and striker 118. A passenger inside the vehicle is able to open door 214 from inside by pulling on door handle lever 224. Pulling on handle lever 224 in the direction of arrow A′ displaces forked end 231 of handle lever 224. The extended end 232 of handle bellcrank 229, slidably received by forked end 231, is displaced responsive to movement of handle lever 224. Displacement of extended end 232 results in pivoting of handle bellcrank 229 about pivot axis 233 in the direction of arrow B′. Pivoting of handle bellcrank 229 repositions first mounting point 260 and second mounting point 264 of handle bellcrank. This repositioning in turn displaces first end fitting 246 of first cable 244 away from latch mechanism 212 and first end fitting 254 of second cable 252 toward latch mechanism 212. Corresponding resultant displacements of second end fittings 248 and 256 cause latch actuation bellcrank 238 to pivot about axis 236 in the direction of arrow C′. The pivoting of bellcrank 238, through the operation of latch mechanism 212, causes the pivoting of latch 216 in the direction of arrow D′ from the latched position of latch 116 of FIG. 4 to the unlatched position of FIG. 3.

When, in a side impact event with an oblique cylindrical pole 268 as illustrated in FIG. 10, door 214 is deformed, and cables 244 and 252 are substantially uniformly displaced. With such uniform displacement, latch actuation bellcrank 238 is not significantly pivoted, and the resulting tension of cables 244 and 252 is substantially equal. With the cables 244 and 252 each acting across a substantially equal distance from pivot axes 233 and 236, the resulting torsional moments cancel each other out. There is thus no net movement of latch actuation bellcrank 238, and latch 216 remains engaged with striker 218.

When an impact induces different tensions in each of cables 244 and 252, for example a force or tension Fl in cable 244 greater than a force or tension F2 in cable 252, the difference in tensions will cause bellcranks 229 and 238 to pivot. The pivoting will result in the higher tension value decreasing and the lower tension value increasing. If there is sufficient pivoting travel available, the tensions will tend to equalize. In one example, latch actuation bellcrank 238 moves a distance of delta L at the first mounting point 262. Stiffnesses of the first cable 244 and second cable 252 are respectively K1 and K2. There is a first cumulative clearance of First Cable Cumulative Hole Clearance equal to a total of a first gap between first end fitting 246 and an opening defining the latch actuation bellcrank's 238 first mounting point 262, and a second gap between second end fitting 248 and an opening defining the handle bellcrank's 229 first mounting point 260. There is a second cumulative clearance of Second Cable Cumulative Hole Clearance equal to a total of a first gap between first end fitting 254 and an opening defining the latch actuation bellcrank's 238 second mounting point 266, and a second gap between second end fitting 256 and an opening defining the handle bellcrank's 229 second mounting point 264. Comparing the tension in cable 244 to what it would be without deflection of either handle bellcrank 229 or actuation bellcrank 238, the delta L results in a tension decrease to:

Cable 244 tension=F1−K1×(delta L−First Cable Cumulative Hole Clearance). Comparing the tension in cable 252 to what it would be without deflection of either handle bellcrank 229 or actuation bellcrank 238, the delta L results in a tension increase to:

Cable 252 tension=F2+K2×(delta L−Second Cable Cumulative Hole Clearance). Barring a travel restriction limiting delta L, the tensions will equalize and movement will cease when

F1−K1×(delta L−First Cable Cumulative Hole Clearance)=F2+K2×(delta L−Second Cable Cumulative Hole Clearance).

When the actuation bellcrank travel delta L is less than a predetermined latch release travel magnitude, latch 216 will remain latched and in engagement with striker 218.

Ideally, both cables 240 and 242 are identical, with cable stiffness K1 and K2 equaling a stiffness value K, and the clearances provided between the associated mounting points 260, 262, 264, and 266 and end fittings 246, 248, 254, 256 are both minimal and identical, providing a cumulative clearance value CC for each cable. The above equation is accordingly simplified to:

F1−K×(delta L−CC)=F2+K×(delta L−CC)

The equation can be solved for delta L:

delta L=(F1−F2)/(2K)+CC

With both cables located proximate to each other, the values of F1 and F2 will be very close and will substantially cancel each other to provide a delta L value very close to zero. As noted above, when the calculation of delta L less is than the predetermined latch release travel magnitude, latch 216 will remain latched and in engagement with striker 218.

Computer model testing indicates that, when compared with the single cable door latch release mechanism 110, the dual cable door latch release mechanism 210 reduces pivoting displacement of latch actuation bellcrank 238, shown by line 270, relative to single cable latch actuation lever 138 displacement, shown by line 272, by 80 percent.

The disclosed door latch release mechanism 210 reduces a likelihood of a door unintentionally being allowed to open as a result of a side impact against the door.

### CONCLUSION

A door latch release mechanism for resisting unintentional disengagement or unlatching has been disclosed.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In the drawings, the same reference numbers indicate the same elements. Further, some or all of these elements could be changed. Alternative embodiments include alternative locations for door latch release mechanism 210 and its constituent elements including latch mechanism 212, striker 218, door handle mechanism 222 and cable assemblies 240, 242. For example, striker 218 could have the form of a single rod instead of a U-shaped form. A slotted end could have been used in place of forked end 231. A third cable could be used as part of the door handle mechanism 222 to connect door handle lever 224 with handle bellcrank 229 in place of the forked end 231 and extended end 232. Latch mechanism 212 could have been illustrated to show receiving elements for ends of each of cable sleeves 250 and 258. Similarly, door handle mechanism could have been illustrated to show receiving elements for ends of each of cables 250 and 258. Latch 216 could pivot about an axis disposed above notch 219 instead of below notch 219. These exemplary alternatives are not comprehensive. In other words, the descriptions of elements herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A door latch release mechanism for use in a passenger vehicle comprising at least one of:
a latch mechanism including a first bellcrank having a first pivot axis and two mounting points; and
a handle mechanism including:
a second bellcrank having a second pivot axis and two mounting points,
a door handle lever having a third pivot axis, and
a mechanical linkage connecting the door handle lever with the second bellcrank.

2. The door latch release mechanism of claim 1, wherein the door latch release mechanism includes each of the latch mechanism and the handle mechanism.

3. The door latch release mechanism of claim 2 wherein the mounting points of each bellcrank are on opposite sides of the pivot axis of such bellcrank and the mounting points are substantially equally spaced from the pivot axis.

4. The door latch release mechanism of claim 3, wherein the mechanical linkage comprises the handle lever slidably engaging the second bellcrank.

5. The door latch release mechanism of claim 4, wherein the second pivot axis is substantially normal to the third pivot axis.

6. The door latch release mechanism of claim 2, further comprising:
a first cable connected at a first end to a first of the two mounting points on the first bellcrank and connected at a second end to a first of the two mounting points on the second bellcrank;
a first cable sleeve slidably disposed over the first cable;
a second cable connected to a second of the two mounting points on the first bellcrank with a second of the two mounting points on the second bellcrank; and
a second cable sleeve slidably disposed over the second cable.

7. The door latch release mechanism of claim 6, further wherein the ends of the cables are each connected to the bellcranks by a pivot joint.

8. A door latch release mechanism for use in a passenger vehicle comprising:
a first bellcrank connected to a latch mechanism and the first bellcrank having a first pivot axis and two mounting points; and
a second bellcrank connected to a handle mechanism and the second bellcrank having a second pivot axis and two mounting points.

9. The door latch release mechanism of claim 8 wherein the mounting points of each bellcrank are on opposite sides of the pivot axis of such bellcrank and the mounting points are substantially equally spaced from the pivot axis.

10. The door latch release mechanism of claim 9, wherein the handle mechanism further includes a door handle lever and a mechanical linkage connecting the door handle lever with the second bellcrank.

11. The door latch release mechanism of claim 10, wherein the handle mechanism further includes the door handle lever being pivotably mounted for rotation about a third pivot axis.

12. The door latch release mechanism of claim 11, wherein the mechanical linkage comprises the handle lever slidably engaging the second bellcrank.

13. The door latch release mechanism of claim 11, wherein the second pivot axis is substantially normal to the third pivot axis.

14. The door latch release mechanism of claim 9, further comprising:
a first cable connected at a first end to a first of the two mounting points on the first bellcrank and connected at a second end to a first of the two mounting points on the second bellcrank;
a first cable sleeve slidably disposed over the first cable;
a second cable connected to a second of the two mounting points on the first bellcrank with a second of the two mounting points on the second bellcrank; and
a second cable sleeve slidably disposed over the second cable.

15. The door latch release mechanism of claim 14, further wherein the ends of the cables are each connected to the bellcranks by a pivot joint.
